(19) United States
(12) Patent Application Publication
(10) Pub. No.: US 2026/0211095 A1
(43) Pub. Date: Jul. 23, 2026

(54) RADAR COORDINATION SET FOR JOINT RADAR SIGNAL PROCESSING

(71) Applicant: GOOGLE LLC, Mountain View, CA (US)

(72) Inventors: Jibing WANG, San Jose, CA (US); Erik STAUFFER, Mountain View, CA (US)

(21) Appl. No.: 19/139,046

(22) PCT Filed: Dec. 12, 2023
(86) PCT No.: PCT/US2023/083677

§ 371 Date: Jun. 13, 2025

Related U.S. Application Data
(60) Provisional application No. 63/432,640, filed on Dec. 14, 2022.

(51) Int. Cl. G01S 13/00; G01S 7/41; G01S 13/46; G01S 13/72

(52) U.S. Cl. CPC G01S 13/003; G01S 7/41; G01S 13/46; G01S 13/72; G01S 2013/468

(57) ABSTRACT

A system and method of forming a radar coordination set (RCS) for multi-static or bi-static radar signal processing is disclosed. The method includes the first base station (102A) transmitting (304), via an Xn interface, at least one message to one or more base stations (102B) requesting base station capability information of a corresponding base station. The method also includes the first base station receiving (306), via the Xn interface, at least one response. Each response of the at least one response comprises the base station capability information of the corresponding base station. The method further includes the first base station forming (308) an RCS (201) with at least one base station (102B) from the one or more base stations based on the base station capability information.

### CROSS REFERENCE TO RELATED APPLICATION(S)

This application claims the benefit of and priority to U.S. Provisional Application Ser. No. 63/432,640, entitled “RADAR COORDINATION SET FOR JOINT RADAR SIGNAL PROCESSING” and filed on Dec. 14, 2022, which is expressly incorporated by reference herein in its entirety.

### TECHNICAL FIELD

The present disclosure relates generally to wireless communication, and more particularly, to systems and methods of radar signal processing.

### BACKGROUND

Radar-type sensing has emerging importance, for example, for the fifth generation (5G)-Advanced or sixth generation (6G) communications. There is growing interest in integrating radar sensing and 5G-Advanced or 6G communications. Mono-static radar is a radar arrangement in which the radar transmitter and the radar receiver are located in the same place and usually form the same radar device. Challenges to implementing mono-static radar in a communications system include self-interference cancelation, which is extremely challenging when transmitted and received signals carry both radar and communication components.

### SUMMARY

The following presents a simplified summary to provide a basic understanding of aspects of the disclosure. This summary is not an extensive overview of all contemplated aspects. Instead, this summary is a prelude to the more detailed description below.

As alluded to above, one of the problems of mono-static radar sensing when integrated into a base station (BS) is the requirement for full duplex capability at the base station. The self-interference experienced by a full duplex base station can be very strong. The base station has to perform complicated or expensive self-interference noise cancelation, which might not be feasible.

The present disclosure addresses the above-noted and other deficiencies by using multiple base stations to form a radar coordination set (RCS) for multi-static or bi-static radar signal processing. Within the RCS, the multiple base stations exchange messages regarding base station capabilities including radar signal processing capabilities over their Xn interfaces. A coordinator of the RCS, which can be implemented by a base station with or without radar transmission or reception capabilities, coordinates with other base stations in the RCS regarding the multi-static or bi-static radar processing. The coordinator might schedule the radar air interface resource for radar waveforms in terms of time, frequency, space, and sequence signature. One or more base stations of the RCS transmits radar waveforms and other base stations of the RCS receives the radar waveforms either directly or as reflected from an object. The transmitting (TX) base station(s) pass, to the receiving (RX) base station(s) over the Xn interface(s), in-phase and quadrature (IQ) samples of the radar waveforms for interference cancelation. The RX base station(s) might send interference-reduced radar reception information messages to the coordinating base station over the Xn interface(s). The coordinating base station(s) may determine radar-detected object properties/parameters and transmit the object information to the TX base station(s), RX base station(s), and other neighbor BSs over the Xn interface.

In some aspects, the present disclosure describes a method performed by a first base station. The method includes the first base station transmitting, via an Xn interface, at least one message to one or more base stations requesting base station capability information of a corresponding base station. The method also includes the first base station receiving, via the Xn interface, at least one response. Each response of the at least one response includes the base station capability information of the corresponding base station. The method further includes the first base station forming an RCS with at least one base station from the one or more base stations based on the base station capability information.

In some aspects, the present disclosure describes a method performed by a second base station. The method includes the second base station receiving, via an Xn interface from a first base station, a message requesting base station capability information. The method further includes the second base station transmitting, via the Xn interface to the first base station, a response including the base station capability information.

In some aspects, the present disclosure describes a base station. The base station includes one or more radio frequency (RF) modems, a processor coupled to the one or more RF modems; and at least one memory storing executable instructions, the executable instructions to manipulate at least one of the processor or the one or more RF modems to perform the method discussed above.

Advantageously, according to embodiments of the present disclosure, the multi-static or bi-static radar signal processing alleviates the requirement for full duplex capability for radar and communication signaling at the base station(s). By implementing this approach, the multi-static or bi-static radar signal processing improves the accuracy of radar processing and reduces the processing cost at the base station side. In addition, this approach allows reuse of downlink communication signals for radar sensing purposes.

### BRIEF DESCRIPTION OF THE DRAWINGS

This description of embodiments and advantages may best be understood in conjunction with the accompanying drawings. These drawings in no way limit any changes in form and detail that may be made to the described embodiments by one skilled in the art without departing from the spirit and scope of the described embodiments.

FIG. 1 is a pictorial diagram illustrating an environment for implementing an RCS for multi-static or bi-static radar signal processing, according to some embodiments.

FIG. 2 is a pictorial diagram illustrating an RCS for multi-static or bi-static radar signal processing, according to some embodiments.

FIG. 3A is a signaling diagram illustrating a process of forming an RCS for multi-static or bi-static radar signal processing, according to some embodiments.

FIG. 3B is a signaling diagram illustrating a process of configuring an RCS for multi-static or bi-static radar signal processing, according to some embodiments.

FIG. 3C is a signaling diagram illustrating a process of executing an RCS for multi-static or bi-static radar signal processing, according to some embodiments.

FIGS. 4A-4B are flow diagrams illustrating a method of a first base station forming an RCS for a multi-static or bi-static radar signal processing, according to some embodiments.

FIGS. 5A-5C are flow diagrams illustrating a method of a second base station for multi-static or bi-static radar reception in an RCS, according to some embodiments.

FIG. 6 is a block diagram illustrating an apparatus that can implement various aspects of an RCS for multi-static or bi-static radar signal processing.

The figures use like reference numerals to identify like elements. A letter after a reference numeral, such as “102A,” indicates that the text refers specifically to the element having that particular reference numeral. A reference numeral in the text without a following letter, such as “102,” refers to any or all of the elements in the figures bearing that reference numeral.

### DETAILED DESCRIPTION

This detailed description below is intended as a description of various configurations and is not intended to represent the only configurations in which the described concepts may be practiced. The present disclosure provides several aspects of communication systems with reference to various apparatus and methods.

For ease of illustration, the following techniques are described in an example context in which one or more base stations implement one or more radio access technologies (RATs) such as the 5G-Advanced or 6G RAT. However, the present disclosure is not limited to networks employing the 5G-Advanced or 6G NR RAT configuration, but rather the techniques described can apply to any combination of different RATs employed at the base stations.

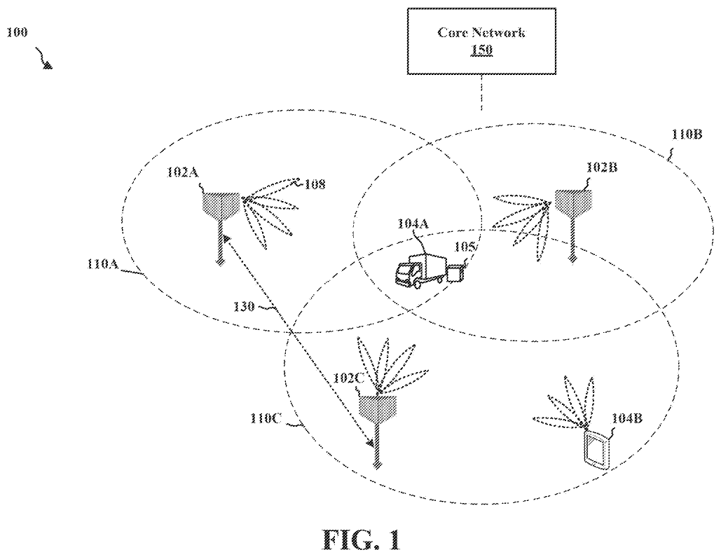

FIG. 1 illustrates an example environment 100 for implementing an RCS for multi-static or bi-static radar signal processing, according to some embodiments. The environment 100 includes base stations 102 (e.g., 102A, 102B, 102C), UEs 104 (e.g., 104A, 104B), and a core network 150 (e.g., a 5G Core (5GC)). The base stations 102 may represent macrocells (high power cellular base station) and/or small cells (low power cellular base station).

The base stations 102 configured for 5G NR (collectively referred to as Next Generation RAN (NG-RAN)) may interface with core network 150 through backhaul links (e.g., NG interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages.

The base stations 102 configured for 5G NR may communicate directly or indirectly with each other over additional backhaul links 130, e.g., Xn interface, 130. The Xn interface 130 may be wired or wireless. The interface interconnecting NG-RAN nodes (e.g., the base stations 102 configured for 5G NR) with each other is referred to as the Xn interface. The Xn interface supports the exchange of signaling information between two NG-RAN nodes, and the forwarding of PDUs to the respective tunnel endpoints.

The base stations 102 may wirelessly communicate with the UEs 104. Each of the base stations 102 may provide communication coverage for a respective geographic coverage area. There may be overlapping geographic coverage areas. For example, the base station 102A has a coverage area 110A that overlaps the coverage area 110B of the base stations 102B and the coverage area 110C of the base station 102C. The communication links between the base stations 102 and the UEs 104 may include uplink (UL) (also referred to as reverse link) transmissions from the UE 104 to the base station 102 and/or downlink (DL) (also referred to as forward link) transmissions from the base station 102 to the UE 104. The communication links may use multiple-input and multiple-output (MIMO) antenna technology, including spatial multiplexing, beamforming, and/or transmit diversity. The communication links may use one or more frequencies.

A base station 102 may be implemented as an evolved Node B (eNB), gNodeB (gNB), or another type of base station and called an access point, a base transceiver station, a radio base station, a radio transceiver, a transceiver function, a basic service set (BSS), an extended service set (ESS), a transmit reception point (TRP), a Central Unit (CU), Distributed Unit (DU), or Remote Unit (RU), or some other suitable terminology. Some base stations, such as gNB, may operate in a traditional sub 6 GHz spectrum (Frequency Range 1 or FR1), in millimeter wave (mmW) frequencies and/or near mmW frequencies (Frequency Range 2 or FR2), or other frequency ranges when in communication with the UE 104. A mmW base station 102 may use this wide bandwidth for radar sensing, which will be discussed in details below. The mmW base station 102 may utilize beamforming with the UE 104 to compensate for the extremely high path loss and short range.

The base station 102 may transmit a beamformed signal to the UE 104 in one or more transmit directions. The UE 104 may receive the beamformed signal from the base station 180 in one or more receive directions. The UE 104 may also transmit a beamformed signal to the base station 102 in one or more transmit directions. The base station 102 may receive the beamformed signal from the UE 104 in one or more receive directions. The base station 102/UE 104 may perform beam training to determine better and worse receive and transmit directions for each of the base station 102/UE 104. The transmit and receive directions for the base station 102 might be the same or different directions but generally they are reciprocal. The transmit and receive directions for the UE 104 might be the same or different directions.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, assembly line components, etc.). The UE 104 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, a wireless transmit-receive point (WTRP), or some other suitable terminology.

Referring again to FIG. 1, integrated communication and sensing, for example, radar-type sensing within a communications network, has emerging importance for 5G-Advanced or 6G communications. The same base station 102 can perform both the communication and sensing by using the same spectrum, potentially using the same signal waveform. Integrated or simultaneous communication and radar sensing has the advantage of leveraging a wireless network as a sensor to compose multi-layered maps of the environment. Radar sensing using the mobile communication network as the sensor has the potential to provide a solution for a potential 6G vision of creating authentic digital representations of the physical world. This potential vision may materialize as wireless communications systems evolve to mmWave bands in 5G and potentially sub-THz bands in 6G.

For example, the base station 102 transmits a wireless signal 108 to a UE 104A and uses information about the signal to image an environment or determine information about an object 104A, 105 based on range, Doppler, and/or angle information determined from the wireless signal as reflected. The signal includes a defined waveform, such as a frequency modulated continuous wave (FMCW), a pulse waveform, or a chirp waveform, among other examples of a defined waveform.

The base station 102 compares reception information of the reflected signal to the transmitted signal to determine information about the object 105 or environment. Radar signal sensing can be employed for automotive radar, e.g., detecting an environment around a vehicle, nearby vehicles or items, detecting information for smart cruise control, collision avoidance, etc. Radar signal sensing can also be employed for gesture recognition, e.g., a human activity recognition, a hand motion recognition, a facial expression recognition, a keystroke detection, sign language detection, etc. Radar signal sensing can be employed to acquire contextual information, e.g., location detection, tracking, determining directions, range estimation, etc. Radar signal sensing can be employed to image an environment, e.g., to provide a 3-dimensional (3D) map for virtual reality (VR) applications. Radar devices can be employed to provide high resolution localization, e.g., for industrial Internet-of-things (IoT) applications.

In some examples, radar signal sensing is based on frequency ranges that overlap with wireless communication systems for the signal 108. For example, the base station 102 uses a waveform for the signal 108 that relates to a communication system. As one non-limiting example, radar signal sensing uses a signal in a mmW frequency range, such as a Frequency Range 2 (FR2), Frequency Range 2x (FR2x), and/or Frequency Range 4 (FR4) signal, which provides improved range for radar signal detection purposes. The base station 102 has the capability to perform radar signal sensing and wireless communication. As illustrated in FIG. 1, the base station 102 can use directional beams to transmit the radar signal 108. For example, the base station 102 transmits the radar signal in a particular direction relative to the base station.

To avoid complicated or expensive self-interference noise cancelation for mono-static radar sensing at a base station, there is an opportunity for the base stations 102 to form the RCS to perform multi-static or bi-static radar signal processing and relieve the requirement for full duplex capability for radar processing at the base station.

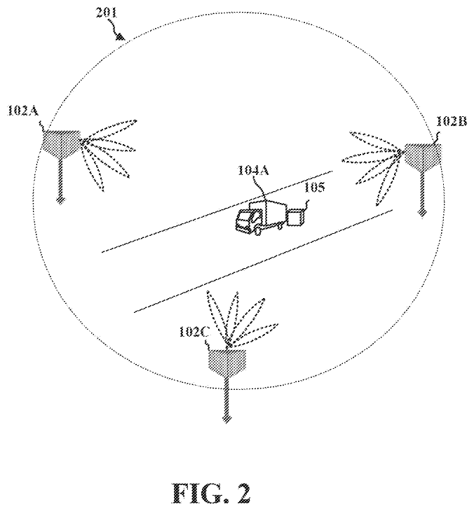

FIG. 2 illustrates an RCS 201 for multi-static or bi-static radar signal processing, according to some embodiments. In order to address the above problems of mono-static radar sensing by a base station, the present disclosure uses multiple base stations (e.g., 102A, 102B, 102C) to form the RCS 201 for the multi-static or bi-static radar signal processing. Within the RCS 201, the multiple base stations (e.g., 102A, 102B, 102C) exchange messages regarding base station capabilities including radar signal processing capabilities over their Xn interfaces (not shown, but see FIG. 1 example backhaul link 130).

As illustrated in FIG. 2, as an example, a base station 102A coordinates with other base stations in the RCS regarding the multi-static or bi-static radar processing. The base station 102A transmits RCS capability request messages over an Xn interface to at least one other base station (e.g., 102B and/or 102C). For example, the RCS capability request messages might include fields for antenna and radar processing capabilities such as antenna array capability, angular resolution, supported radar signal band(s) and the associated bandwidth, supported radar waveform, IQ sample processing capability. The base station 102A receives RCS capability responses over the Xn interface from the at least one other base station (e.g., 102B and/or 102C). The base station 102A forms the RCS 201 with at least one other base station (e.g., 102B and/or 102C) based on the exchanged base station capability information. By default, the initiating base station 102A is a coordinator of the RCS 201, but additional control signals may be exchanged to negotiate transfer of the coordinator role.

The base station 102A, as the coordinator of the RCS 201, schedules the air interface resources for radar waveforms in terms of time, frequency, space, and sequence signature. With multiple radar transmitters/receivers, time, frequency, space, and coordination is important. The base station 102A may assign some base stations of the RCS for the multi-static radar transmission and other base stations of the RCS for multi-static radar reception. The transmitting base stations of the RCS 201 transmit radar waveforms and the receiving base station(s) might receive the radar waveforms, e.g., either directly or as reflected from an object. The radar waveforms may be formed from mmWave 5G or 6G communications signals intended for served UEs (not shown in FIG. 2).

As an example, the base station 102A assigns itself a role as transmitting base station and both the base stations 102B, 102C roles as receiving base stations. The base station 102A might beamform on the transmitting side, while the base station 102B, 102C might perform reception beamforming.

The transmitting base station 102A passes baseband in-phase and quadrature (IQ) samples of the radar wireless waveforms, which might also carry communication information as mentioned earlier, to the receiving base station 102B, the base station 102C over the Xn interface for use in interference cancelation. Afterwards (or possibly beforehand) the transmitting base station 102A transmits the modulated radar wireless waveforms using designated air interface resources, and one or more of the receiving base stations 102B, 102C may receive these waveforms either directly or after reflection by objects 104A, 105. The receiving base stations 102B, 102C demodulate the reflected and direct radar wireless waveforms. Then, the receiving base stations 102B, 102C subtract the baseband in-phase and quadrature (IQ) samples received over the Xn interface from the received demodulated radar wireless waveforms to reduce interference caused by the direct radar wireless waveforms. Afterwards, the receiving base stations 102B, 102C send their individual resulting interference-reduced radar reception information in separate messages to the coordinating base station 102A over the Xn interface. The coordinating base station 102A determines object properties/parameters from the radar reception information messages. For example, the coordinating base station 102A uses an angle of departure/arrival (and locations of each base station) to determine object information. The base station 102A transmits the object information to the base station 102B, the base station 102C, and/or other neighbor BSs (not shown) over the Xn interface. The other neighbor BSs might include base stations without radar capabilities. The coordinating base station 102A may also send object information to a server or another network entity to assist in mapping, traffic, public safety, or other applications.

As another example, the coordinating base station 102A assigns base station 102B a role as transmitting base station and another base station 102C a role as receiving base station. The base station 102B is beamforming on the transmitting side, while the base station 102C is beamforming on the receiving side. The transmitting base station 102B passes, over the Xn interface (not shown), in-phase and quadrature (IQ) samples of the baseband radar waveforms to the receiving base station 102C for use in interference cancelation. The transmitting base station 102B also sends this radar signal information in a message to the coordinating base station 102A over the Xn interface. After the transmitting base station 102B sends the modulated radar wireless waveform using designated air interface resources, the receiving base station 102C receives the modulated radar wireless waveform either directly or as reflected from various objects 105, 104A. The receiving base station 102C uses the IQ samples to reduce interference caused by reception of direct radar wireless waveforms and sends interference-reduced radar reception information in a message to the coordinating base station 102A over the Xn interface. Similar to the prior example, the coordinating base station 102A determines object properties/parameters from the radar signal information (as received in the message from the transmitting base station 102B) and the radar reception information (as received in the message from the receiving base station 102C).

As an example of a use case, the RCS 201 of the base stations (102A, 102B and/or 102C) might assist highway & autonomous fleet navigation. The RCS 201 can perform moving and/or stationary object detection. As illustrated in FIG. 2, the base station 102A can transmit a beamformed signal, in one or more transmit directions, to detect one or more objects 104A, 105. For example, the object 105 can be a stationary object (e.g., refrigerator) dropped off from a moving vehicle 104A. The objects 104A, 105 reflect the beamformed signal transmitted from the transmitting base station 102A. The receiving base stations 102B, 102C can receive these reflections of the transmitted beamformed signal. The receiving base stations 102B, 102C send interference-reduced radar reception information messages to the base station 102A over their respective Xn interfaces. The coordinating base station 102A can determine properties/parameters of the objects 104A, 105 from the radar reception information messages. When the beamformed transmissions occur periodically, the coordinating base station can distinguish stationary objects 105 from moving objects 104A and, for example, transmit the object information for stationary objects to the base station 102B, the base station 102C, and/or other neighbor BSs over the Xn interface. The coordinating base station 102A can notify highway authorities or route fleet around the object 105 or other unexpected stationary/slow-moving objects. Using these tactics, the base station 102A can generate a high precision map for autonomous driving vehicles in the nearby area. The multi-static or bi-static radar signal processing can be used in many other applications as well.

Advantageously, the multi-static or bi-static radar signal processing performed by the RCS 201 alleviates the requirement for full duplex capability for radar processing for the base station(s), improves the radar signal SNR, increases the accuracy of radar processing, and reduces the component or operational costs at the base station side. In addition, this approach supports reuse of downlink communication signals for radar sensing purposes to improve the overall efficiency.

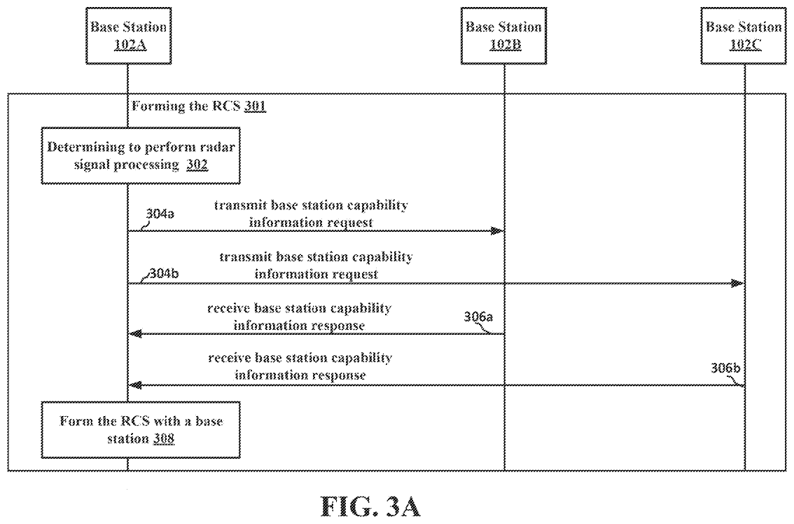

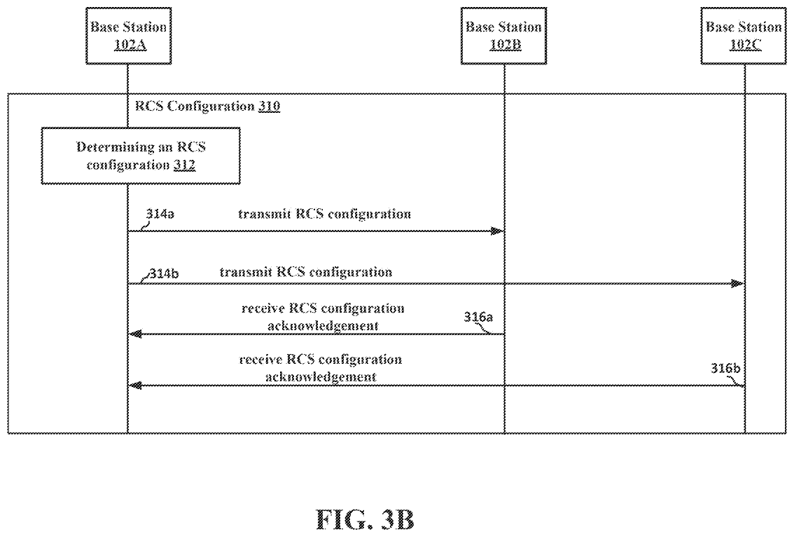

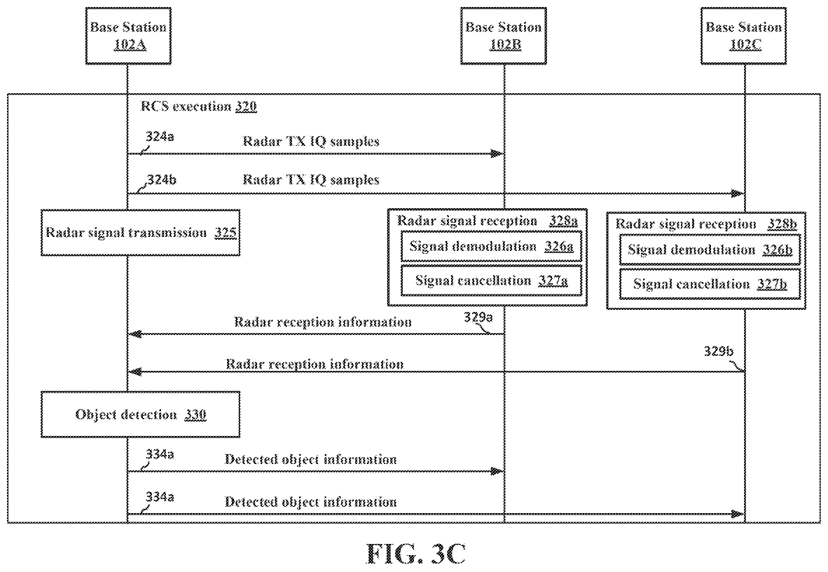

FIGS. 3A-3C illustrate a process of forming 301, configuring 310, and executing 320 an RCS (e.g., 201) for multi-static or bi-static radar signal processing, according to some embodiments. When forming 301 an RCS 201, a coordinating base station initiates an exchange of base stations capabilities. When configuring 310 an RCS 201, a coordinating base station (which may be the prior coordinating base station or may be a different base station due to a transfer of the coordination role) assigns a role of “transmitting base station” or “receiving base station” to base stations in the RCS 201. And when executing 320, the transmitting base station of an RCS 201 transfers baseband I/Q samples of the radar wireless waveform to the receiving base station(s) of the RCS 201 and the coordinating base station using a backhaul such as an Xn interface. Also as part of executing 320, the transmitting base station transmits a wireless signal that modulates the baseband radar signal. When a receiving base station of the ACS receives the wireless signal, it performs radar signal reception with interference cancelation based on the IQ samples. The receiving base station(s) send the resulting interference-reduced radar reception information in a message to the coordinating base station. The coordinating base station detects the object based the transmitting base station's baseband I/Q samples and reception information from all of the receiving base stations for the bi-static/multi-static radar operation. The coordinating base station may send the object information to other base stations, a server, or another network entity.

FIG. 3A illustrates a process of forming 301 the RCS for the multi-static or bi-static radar signal processing, according to some embodiments. Referring to FIG. 3A, when forming 301 the RCS, the base station 102A might adopt a coordinating base station role and determine 302 to perform radar signal processing with nearby base stations. The base stations (e.g., 102A, 102B, 102C) can communicate with each other to form the RCS for radar sensing processing. For example, the coordinating base station 102A sends a message to a set of base stations to request/receive BS capability information. Next, the coordinating BS 102A evaluates the received BS capabilities of each of the set of base stations to determine if the coordinating BS's radar sensing requirements can be met. Then, the coordinating BS 102A selects one or more base stations from the set of base stations to form the RCS, if the one or more base stations meet the coordinating BS's radar sensing requirements. If no base station can meet the coordinating BS's radar sensing requirements, the coordinating BS does not create the RCS. The radar sensing requirements might take into account base station location information, base station capability information, and/or base station load information.

The radar sensing requirements might include requirements regarding coverage of a particular geographic area based on base station location information, including the sensing range, angle/direction requirements, or other geographic information (such as whether high building/blocker is present). As an example, the initiating base station might set its requirement based on its own use case (e.g., to establish a high-precision map for a certain area to optimize beam management).

The radar sensing requirements might include requirements for base station capability based on base station capability information (base station capability information akin to UE capability information). The base station capability information might include antenna array capability for angular resolution, radar signal processing capability (e.g., the bandwidth supported, radar waveform supported), and/or IQ sample processing capability (for when IQ samples pass through a backhaul link 130). The requirement might be a certain radar resolution. For example, the coordinating base station 102A may request a base station with a reception resolution above a threshold radar resolution to join the RCS.

The radar sensing requirements might also include requirements for a base station load determined based on base station load information. For example, a base station experiencing a high load while handling a lot of active communicating might not be able to timely process additional RCS signaling due to the existing high cellular load and/or RCS signaling. The requirement might be a certain percentage of base station load. For example, a base station with a load below a load percentage threshold can join the RCS. The base station load might be measured based on parameters such as central processing unit (CPU)/digital signal processing (DSP) cycle availability (e.g., percentage of the millions of instructions per second (MIPS) vs maximum MIPS), available memory for radar processing. The parameters might be specific for the RCS.

Still referring to FIG. 3A, based on the radar sensing requirements, the base station 102A might determine to invite at least one base station (e.g., 102B and/or 102C) of the nearby base stations to join the RCS. The base station 102A transmits 304 one or more base station capability information request messages to the at least one base station (e.g., 102B and/or 102C). Specifically, the base station 102A transmits 304A, 304B base station capability information request messages to respective base stations 102B, 102C. The base station capability information request message might include request for antenna array capability, radar signal processing capability, or base station location information. For example, the base station capability information request message includes fields for antenna array capability and radar signal processing capabilities (e.g., radar bandwidth, radar waveform, I/Q sample processing capability, interference cancellation support, current base station loading) as well as the base station location information. For another example, the base station capability information request message just a simple request, while the detailed information regarding antenna array capability, radar signal processing capability, or base station location information is part of a base station capability information response message.

The base station 102A receives the base station capability information response message from the at least one base station (e.g., 102B and/or 102C). For example, the base station 102A receives 306A the base station capability information response message from the base station 102B; and the base station 102A receives 306B the base station capability information response message from the base station 102C.

Based on the base station capability information response message from the at least one base station (e.g., 102B and/or 102C), the base station 102A forms 308 the RCS 201 with the at least one base station (e.g., 102B and/or 102C). The base station 102A might determine whether the at least one base station (e.g., 102B and/or 102C) is suitable for the radar sensing purpose, and then determine whether to form the RCS with the at least one base station (e.g., 102B and/or 102C). As an example, the base station 102A determines the base station 102B, but not the base station 102C, is suitable for radar sensing based on the base station capability information response message. In this case, the base station 102A may not transmit RCS configuration message to the base station 102C. Thus, the base station 102A forms the RCS with the base station 102B. As another example, the base station 102A determines both the base station 102B and the base station 102C are suitable for radar sensing based on the base station capability information response messages, and forms the RCS with the base station 102B and the base station 102C. As still another example, the base station 102A determines neither the base station 102B nor the base station 102C is suitable for radar sensing based on the base station capability information response messages, and thus does not form the RCS.

By default, the initiating base station 102A is the coordinator of the RCS (e.g., 201). The coordinator of the RCS is responsible for establishing the RCS. The coordinator of the RCS is responsible to assign some base stations in the RCS to perform the bi-static/multi-static transmission and assign other base stations in the RCS to perform the bi-static/multi-static reception as discussed with reference to FIG. 3B.

By this process, the coordinating base station 102A forms 301 the RCS 201 with the at least one base station (e.g., 102B and/or 102C) based on the base station capability information request and response procedure in order to perform the bi-static or multi-static radar signal processing based on the sensing requirements. FIG. 3B will discuss the configuration of the RCS below.

FIG. 3B illustrates a process of configuring 310 the RCS for the multi-static or bi-static radar signal processing, according to some embodiments. In this next procedure, the base station 102A determines 312 the RCS configuration. The RCS configuration might indicate radar waveform resource in terms of time, frequency, space (beam form and directionality), and sequence signature. The coordinator, e.g., the base station 102A, determines how to schedule radar resources (time, frequency, space) to support one or more base stations transmitting radar waveforms and other one or more base stations receiving the radar waveforms.

The base stations within the RCS negotiate the RCS configuration over the Xn interfaces. For example, multiple base stations within the RCS might transmit the radar waveform in a time-division multiplexing (TDM), frequency-division multiplexing (FDM), Space Division Multiplexing (SDM), and/or code division multiplexing (CDM) fashion. By TDM, multiple base stations can transmit radar waveforms that are separated in time domain. For each transmitting base station, there might be multiple base stations performing the multi-static reception. By FDM, multiple base stations can transmit radar waveforms that are separated in the frequency domain, for example, on different frequency bands or on different frequencies within the same frequency band. By SDM, multiple base stations can transmit radar waveforms that are separated by the different spatial/angular directions. Since the base stations are beamforming, the base stations can steer their transmission in different directions, which can help to separate different base station transmissions and avoid interference. By CDM, multiple base stations can transmit radar waveforms that are separated by the different code/sequence signature. Different base stations can have different waveforms. Each waveform can have its own sequence signature. The base stations can perform correlation based scheme based on the code/sequence signature. A combination of TDM/FDM/SDM/CDM might be used, as long as the synchronization is maintained across the base stations.

The coordinator base station, e.g., the base station 102A, coordinates the TDM/FDM/SDM/CDM of radar sensing cooperation. In addition, the coordinator base station also allocates the base stations for radar sensing receptions and transmission. The coordinator base station can allocate a subset of base stations to perform the bi-static/multi-static transmission while another subset of base stations performs the bi-static/multi-static reception. The allocation can change based on dynamic changes in the base station capability, such as loading of each base station. The base stations might communicate via Xn messages to change the role of the coordinator. A different base station (e.g., 102B or 102C) might later become the coordinator of the RCS. For example, one base station in RCS performs the bi-static/multi-static transmission while the other RCS base stations perform the bi-static/multi-static reception. As another example, multiple RCS base stations performs the bi-static/multi-static transmission and one RCS base station performs the bi-static/multi-static reception. It is also possible to change the roles of transmit base stations with receive base stations for radar sensing purposes. As an example, the coordinator, which is the base station 102A, performs the bi-static/multi-static transmission during one radar cycle. Then for another radar cycle, the coordinator, e.g., the base station 102A, performs bi-static/multi-static reception. The coordinating role of the RCS can be transferred to a different base station in the process as well.

For example, the base station 102A transmits the RCS configuration messages with the RCS configuration for each transmission. The base station 102A configures a “one-shot” multi-static/bi-static radar transmission. The base station 102A transmits the RCS configuration messages indicating a radar waveform for a future time slot. As another example, the base station 102A transmits the RCS configuration messages with the RCS configuration for multiple transmissions. The base station 102A transmits the RCS configuration messages indicating scheduling information for a batch of transmissions or receptions. The base station 102A might configure the multi-static/bi-static radar transmission periodically or repeatedly.

Still referring to FIG. 3B, the base station 102A transmits RCS configuration messages with the RCS configuration to the at least one other base station (e.g., 102B and/or 102C) in the RCS. For example, the base station 102A transmits 314a the RCS configuration message with the RCS configuration to the base station 102B. The base station 102A transmits 314b the RCS configuration message with the RCS configuration to the base station 102B.

The at least one other base station (e.g., 102B and/or 102C) in the RCS sends an RCS configuration acknowledgement message. The base station 102A receives the RCS configuration acknowledgement message from the at least one base station (e.g., 102B and/or 102C) in the RCS. For example, the base station 102A receives 316a the RCS configuration acknowledgement message from the base station 102B. The base station 102A receives 316b the RCS configuration acknowledgement message from the base station 102C.

Using this RCS configuration process, the coordinating base station configures the base stations in the RCS to perform bi-static/multi-static radar transmission or reception operations in terms of time, frequency, space, and/or and sequence signature. The RCS next performs the bi-static/multi-static radar operations in a manner that potentially reuses 5G-Advanced or 6G downlink wireless communications to a UE.

FIG. 3C illustrates a process of an RCS executing 320 multi-static or bi-static radar signal processing, according to some embodiments. After receiving 316 the RCS configuration acknowledgement message(s) shown in FIG. 3B, a coordinating base station 102A that also has the role of a transmitting base station sends the IQ samples of a radar signal over the Xn interface to the at least one receiving base station (102B and/or 102C) of the RCS.

Referring to FIG. 3C, for each radar signal, there are associated baseband IQ samples. The base station 102A sends the IQ samples of the radar signal to the base station 102B and/or 102C. For example, the base station 102A sends 324a the IQ samples of the radar signal over the Xn interface to the base station 102B. The base station 102A sends 324b the IQ samples of the radar signal over the Xn interface to the base station 102C. These IQ samples may be in-phase and quadrature components of a base band downlink signal generated by the transmitting base station for communication with a UE (shown in FIG. 1) and also used for radar sensing. The base station 102B and/or 102C receive, via the Xn interface, the I/Q samples shortly before receiving a transmitted radio signal. The base station 102B and/or 102C receives the IQ samples of the radar signal (e.g., the transmitted down link signal) before receiving the radar signal to properly correlate the received signal after demodulation.

The base station 102A transmits 325, via an antenna over the air, a wireless signal that modulates the base band downlink signal and transmits the radio frequency signal at a time, frequency, and beam space indicated in the configuration 310 of FIG. 3B, e.g., towards an area that may contain an object (e.g., 105). The TX base station can use a pure radar waveform for the radar sensing purpose. The base stations can also use a downlink communication waveform for the radar sensing purpose. For example, referring back to FIG. 2, the base station 102A can transmit a downlink signal to the UE 104A. The same downlink signal from that base station 102A can also be used as a radar signal to detect the object 105. The receiving base station(s) (e.g., 102B and/or 102C) can receive the “reflected” or “returned” radar signal from the objects 104A, 105 based on the downlink signal from the base station 102A. Thus, the same waveform can serve both the communication purpose and the radar sensing purpose, to improve the overall efficiency.

When a receiving base station (102B and/or 102C) of the RCS receives 328 the wireless signal in accordance with the configuration 310 received in FIG. 3B, it performs the radar signal reception processing. The receiving RCS base station may also perform 327 interference cancellation using the radar TX IQ samples. Referring to FIG. 2 and FIG. 3C, the receiving base station(s) (102B and/or 102C) of the RCS, via antenna(s), perform 328a the radar signal reception. For example, the base station 102B, via its antenna, performs 328a the radar signal reception. The base station 102C, via its antenna, performs 328b the radar signal reception. As an example, the base station 102B receives a modulated version of the radar signal on the time/frequency indicated in the RCS configuration 310. The modulated version of radar signal may include a modulated downlink transmission signal for communication to a UE. The base station 102B demodulates 326a the modulated version of the radar signal, then samples the resulting base band signal. The base station 102B cancels (subtracts) 327a the base band IQ samples. Similarly, the base station 102C receives a modulated version of the radar signal on the time/frequency indicated in the RCS configuration 310. The base station 102C demodulates 326b the radar signal, samples the resulting base band signal, and then cancels (subtracts) 327b the base band IQ samples to produce a radar signal reception with interference cancelation.

The base station 102B and/or 102C can determine some characteristics (e.g., the path delay and/or Doppler angle information) of the reflected radar signal. The base station 102B and/or 102C can receive the reflected path radar signal (e.g., a radar signal reflected from the object 105) and the direct-path radar signal from the base station 102A directly to the base station 102B and/or 102C. The direct-path radar signal might be much stronger than the reflected path radar signal, thus, it can be difficult for the base station 102B and/or 102C to distinguish the reflected path radar signal. The base station 102B and/or 102C perform interference cancelation, which is a cancellation of the direct-path radar signal from the base station 102A directly to the base station 102B and/or 102C. The base station 102B and/or 102C cancel the direct-path radar signal based on the IQ samples of the radar signal as described above. Then, after cancelling the direct-path signal interference, the base station 102B and/or 102C can process the reflected path radar signal with a higher SNR.

Then, the receiving RCS base station, e.g., base station 102B and/or 102C, sends 329 the reception information after interference cancelation to the coordinating base station 102A using, for example, an Xn interface. For example, the base station 102B, 102C transmits 329a, 329b, via their respective Xn interfaces to the base station 102A, the reception information after the interference cancelation. The reception information can include the characteristics including the path delay and/or Doppler angle information of the reflected radar signal. The reception information can be considered “echoes” of the transmit signal off the object (minus the “directly-received” version represented by the IQ samples).

The coordinating base station 102A detects 330 the object based on transmission information such as the baseband IQ samples and reception information from the at least one base station (102B and/or 102C) for the bi-static/multi-static radar operation. As an example, as illustrated in FIG. 2, the base station 102A might use the reception information including the path delay and/or Doppler angle information to detect the object 105. The base station 102A can determine properties/parameters (e.g., the position and/or speed) of the object 105.

Then, the coordinating base station 102A optionally sends the object information to other base stations, a server, or another network entity. For example, the base station 102A sends 334a, 334b the object information to the other RCS base stations 102B, 102C. As illustrated in FIG. 2, the base station 102A transmits the object information of the objects 104A, 105 to the base station 102B and/or the base station 102C and other neighbor base stations (not shown) over the Xn interface. For example, the object information includes the position and/or speed information related to the object. The base station 102A can notify highway authorities or route fleet around the object 105 or other unexpected stationary/slow-moving objects. The base station 102A can generate a high precision map for autonomous driving vehicles in the nearby area. The multi-static or bi-static radar signal processing can be used in many other applications as well.

By this process, the base stations (e.g., 102A, 102B, 102C) of the RCS perform the bi-static/multi-static radar sensing, which alleviates the requirement for full duplex capability for radar processing for the base stations. By performing the bi-static/multi-static radar sensing, the RCS improves the radar signal SNR, increases the accuracy of radar processing, and reduces the processing cost at the base station side. In addition, the RCS reuses the downlink communication signals for radar sensing purposes, thereby improving the overall efficiency.

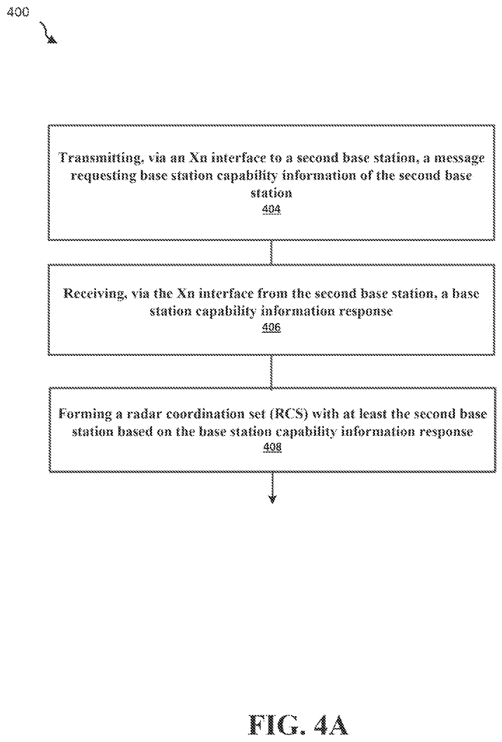

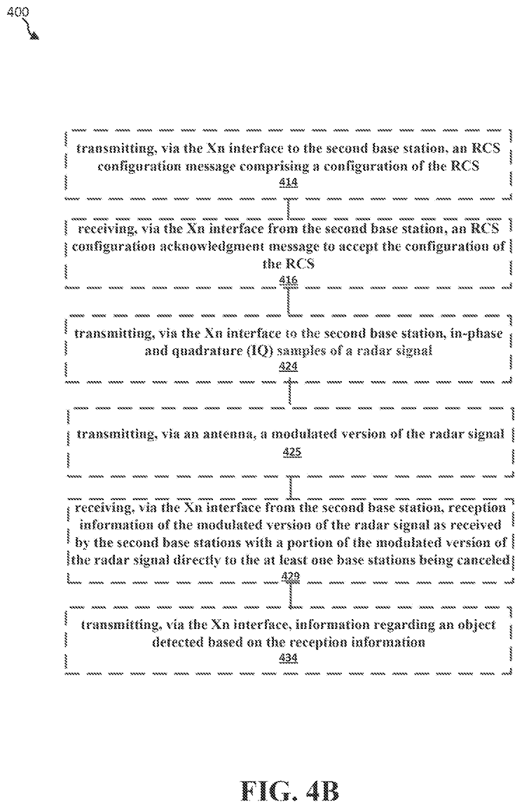

FIGS. 4A-4B are flow diagrams illustrating a method 400 of a coordinating base station forming an RCS for a multi-static or bi-static radar signal processing, according to some embodiments. The method 400 is performed by the coordinating base station, for example, the base station 102A. As described with connection to FIGS. 3A-3C, the coordinating base station (e.g., 102A) transmits base station capability information request message to a base station 102B). Based on the base station capability information response message from the base station 102B, the coordinating base station (e.g., 102A) forms the RCS (e.g., 201) with the second base station 102B. The coordinating base station transmits an RCS configuration request message with an RCS configuration to the base station 102B. Then, the coordinating base station sends, over the Xn interface to the base station 102B, the IQ samples, e.g., in-phase and quadrature components of a base band downlink signal to a UE. The coordinating base station transmits a wireless signal that modulates the base band downlink signal. The coordinating base station detects the object based on reception information from the base stations 102B for the bi-static/multi-static radar operation, and sends the object information to other base stations.

Referring to FIG. 4A, the method 400 includes the coordinating base station (e.g., 102A) transmitting 404, via an Xn interface to the base station 102B, a BS capability information request message requesting base station capability information of the base station 102B, for example, as discussed with connection to 301 in FIG. 3A.

The method 400 includes the coordinating base station (e.g., 102A) receiving 406, via the Xn interface from the base station 102B, a BS capability information response to the request. The response includes the second base station capability information of the base station 102B. For example, the coordinating base station (e.g., 102A) receives, from the base station 102B, radar signal processing capability and location information. The coordinating base station (e.g., 102A) might receive at least one of: antenna array capability for an angular resolution, radar signal processing capability, or I/Q sample processing capability. The coordinating base station (e.g., 102A) might receive load information of the base station. For example, the BS capability information response includes fields for antenna array capability and radar signal processing capabilities (e.g., radar bandwidth, radar waveform, I/Q sample processing capability, interference cancellation support, current base station loading) as well as the base station location information.

The method 400 includes the coordinating base station (e.g., 102A) forming 408 the RCS with a base station 102B based on the base station capability information. For example, referring back to FIG. 3A, based on the base station capability information response message from the base station 102B or 102C, the base station 102A forms 308 the RCS 201 with the base station 102B or 102C. The base station 102A might determine whether the base station 102B or 102C is suitable for the radar sensing purpose, and then determine whether to form the RCS with the base station 102B or 102C. For example, the base station 102A determines whether the base station 102B or 102C is suitable for the radar sensing purpose based on the base station (e.g., 102B/102C) locations, radar processing capability (such as antenna arrays size, radar waveform supported, interference cancellation capability), and loading information.

Referring to FIG. 4B, the method 400 might include the coordinating base station (e.g., 102A) transmitting 414, via the Xn interface to the base station 102B, an RCS configuration message including a configuration of the RCS. For example, referring back to FIG. 3B, the base station 102A determines 312 the RCS configuration. The RCS configuration might include radar waveform resource in terms of time, frequency, space, and sequence signature. For example, the RCS configuration has both common-to-all RCS BSs and unique-to-some RCS BS components.

As an example, the coordinating base station (e.g., 102A) transmits, via the Xn interface, information regarding multiple radar waveforms being transmitted separately in a time domain, in a frequency domain, by different spatial/angular directions, or by different code/sequence signature, or by a combination thereof, as described in connection with 312 in FIG. 3B.

As another example, the coordinating base station (e.g., 102A) transmits, via the Xn interface, indications designating a first subset of the RCS for multi-static radar transmission and a second subset of the RCS for multi-static radar reception. The coordinating base station (e.g., 102A) might update, via the Xn interface, the first subset of the RCS and the second subset of the RCS dynamically based on radar sensing requirements. For example, the radar sensing requirements used to update the TX or RX base stations include range resolution, doppler resolution, angular resolution, etc.

Referring to FIG. 4B, the method 400 might include the coordinating base station (e.g., 102A) receiving 416, via the Xn interface from the base station 102B, an RCS configuration acknowledgment message to accept the configuration of the RCS. For example, referring back to FIG. 3B, the coordinating base station 102A receives 316 the RCS configuration acknowledgement message from the base station 102B or 102C.

As an example, the coordinating base station 102A might assign itself to be a TX BS of the RCS. When the base station 102A is the TX BS, the method 400 might include the base station (e.g., 102A) transmitting 424 via the Xn interface to the base station 102B, IQ samples of a baseband radar signal, for example, as described in connection with 324a, 324b in FIG. 3C.

Then, the method 400 might include the TX base station (e.g., 102A) transmitting 425, via an antenna, a modulated version of the radar signal. For example, the modulated version of radar signal includes a modulated downlink transmission signal for communication. For example, referring back to FIG. 3C, the base station 102A transmits 325 over the air, the radar signal, e.g., towards an object (e.g., 105). The base stations can alternatively use a pure radar waveform for the radar sensing purpose.

Afterwards, the method 400 might include the coordinating base station (e.g., 102A) receiving 429, via the Xn interface, from the base station 102B, reception information of the modulated version of the radar signal as received by the base station 102B with a portion of the modulated version of the radar signal canceled, for example, as described in connection with 329a, 329b in FIG. 3C.

As another example, the coordinating base station 102A might assign a different BS to be a TX BS of the RCS (not shown). As discussed above in connection with FIG. 2, the coordinating base station 102A assigns base station 102B a role as TX base station and another base station 102C a role as RX base station. Then, the coordinating base station 102A receives the radar signal information from the TX BS 102B and the reception information from the RX BS 102C. Afterwards, the coordinating base station 102A determines object properties/parameters from the radar signal information (as received in the message from the TX BS 102B) and the radar reception information (as received in the message from the RX BS 102C).

Still as another example, the coordinating base station 102A might assign itself as an RX BS of the RCS (not shown). The coordinating base station 102A assigns base station 102B a role as TX base station. Then, the RX base station 102A receives, via the Xn interface from the TX BS 102B, IQ samples of a baseband radar signal the radar signal. The RX base station 102A performs the radar signal reception. The receiving base station may also perform interference cancellation using the radar TX IQ samples. Afterwards, the coordinating base station 102A determines object properties/parameters from the radar signal information (as received in the message from the TX BS 102B) and the radar reception information.

Finally, the method 400 might include the coordinating base station (e.g., 102A) transmitting 434, via the Xn interface, information regarding an object detected based on the reception information, for example, as described in connection with 334 in FIG. 3C.

Using the method 400, the coordinating base station (e.g., 102A) forms the RCS to perform the multi-static or bi-static radar signal processing, which alleviates the requirement for full duplex capability for radar processing for the base station(s), improves the radar signal SNR, increases the accuracy of radar processing, and reduces the operating cost at the base station side. In addition, the method allows reuse of downlink communication signals for radar sensing purposes to improve the overall efficiency. The method performed by the receiving base station will be discussed below.

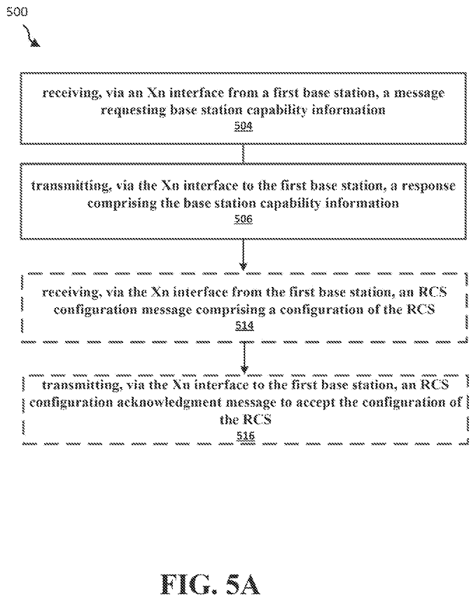

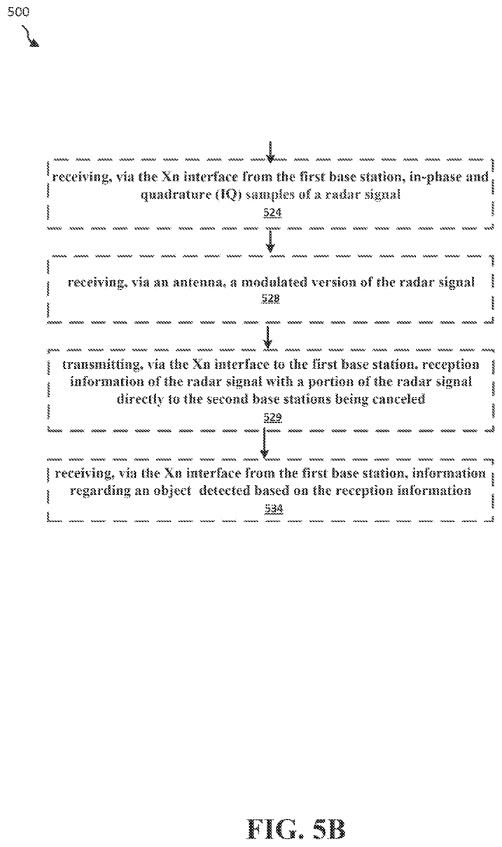

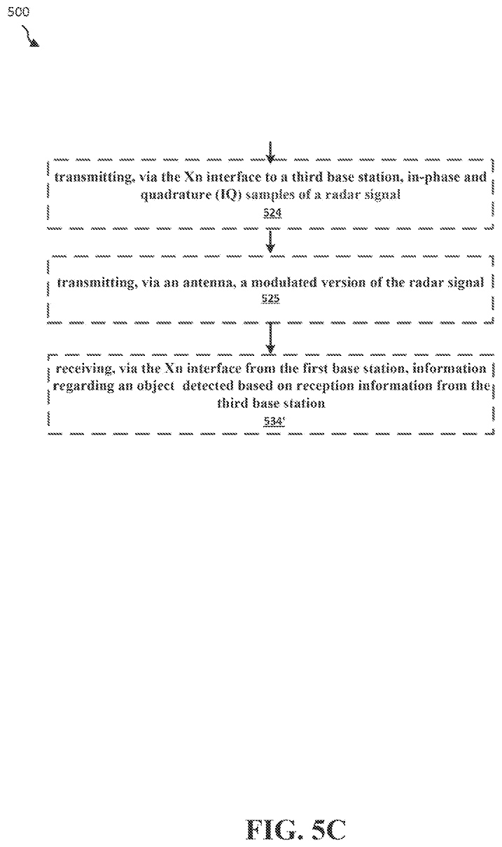

FIGS. 5A-5C illustrate a method 500 of a receiving base station for a multi-static or bi-static radar reception in an RCS, according to some embodiments. The method 500 is performed by a base station in a non-coordinating base station role, for example, the base station 102B or 102C. As described with connection to FIGS. 3A-3C, the non-coordinating base station exchanges messages with the coordinating base station regarding base stations capabilities. The non-coordinating base station might have a role of “receiving base station” or “transmitting base station” in the RCS 201. As a receiving base station of the ACS, the base station 102B receives the baseband I/Q samples of the radar wireless waveform to the transmitting base station the base station. Then, the base station 102B receives the wireless signal, and it performs radar signal reception with interference cancelation based on the IQ samples. The receiving base station sends the resulting interference-reduced radar reception information in a message to the coordinating base station. As a transmitting base station of an RCS 201, the base station 102B transfers baseband I/Q samples of the radar wireless waveform to the receiving base station of the RCS 201 using a backhaul such as an Xn interface. Then, the transmitting base station transmits a wireless signal that modulates the baseband radar signal. The non-coordinating base station might receive the object information from the coordinating base station.

Referring to FIG. 5A, the method 500 includes the non-coordinating base station 102B receiving 504 via an Xn interface from a coordinating base station 102A, a BS capability information request message requesting base station capability information, for example, as discussed in connection with 304 in FIG. 3A.

In response to the BS capability information request message, the method 500 includes the non-coordinating base station (e.g., 102B or 102C) transmitting 506, via the Xn interface to the coordinating base station, a BS capability information response including the base station capability information. For example, as discussed in connection with 306 in FIG. 3A, if the non-coordinating BS 102B meets the coordinating BS's radar sensing requirements, the coordinating BS 102A selects the non-coordinating BS 102B to form the RCS.

Still referring to FIG. 5A, the method 500 might include the non-coordinating base station receiving 514, via the Xn interface from the coordinating base station after being selected to form the RCS, an RCS configuration message including a configuration of the RCS, for example, as discussed in connection with 314 in FIG. 3B.

Then, the method 500 might include the non-coordinating base station transmitting 512, via the Xn interface to the coordinating base station, an RCS configuration acknowledgment message to accept the configuration of the RCS. For example, referring back to FIG. 3B, the base station 102B or 102C in the RCS sends an RCS configuration acknowledgement message.

As discussed above in connection with FIG. 2, the non-coordinating base station might have a role as an RX base station or a TX base station. As an example, the non-coordinating base station 102B has the role as the RX BS. Referring to FIG. 5B, the method 500 might include the base station 102B receiving 524, via the Xn interface from the TX base station, in-phase and quadrature (IQ) samples of a baseband radar signal, for example, as described in connection with 324a, 324b in FIG. 3C.

Then, the method 500 might include the base station 102B receiving 528, via an antenna from the transmitting base station, a modulated version of the radar signal on the time/frequency indicated 514 in the RCS configuration. For example, the modulated version of radar signal includes a modulated downlink transmission signal for communication to a UE, for example, as discussed in connection with 328 in FIG. 3C.

As another example, the non-coordinating base station 102B has the role as the TX BS. Referring to FIG. 5C, the method 500 might include the TX base station 102B transmitting 524, via the Xn interface to an RX base station, in-phase and quadrature (IQ) samples of a baseband radar signal, for example, as described in connection with 324a, 324b in FIG. 3C. The RX base station might be a different BS, e.g., 102C, instead of the coordinating BS 102A. Alternatively, The RX base station might be the coordinating BS 102A.

Then, the method 500 might include the TX base station 102B transmitting 525, via an antenna to the RX base station, a modulated version of the radar signal on the time/frequency indicated 514 in the RCS configuration, for example, as discussed in connection with 325 in FIG. 3C.

Finally, referring to FIG. 5B and FIG. 5C, the method 500 might include the non-coordinating base station receiving 534 or 534′, via the Xn interface from the coordinating base station, information regarding an object detected based on the reception information when the non-coordinating base station is the RX BS or the TX BS respectively, for example, as described in connection with 334 in FIG. 3C.

The method 500 might also include the receiving base station receiving (not shown), via the Xn interface from the coordinating base station, a role change message requesting to transfer a role of a coordinator of the RCS to the second base station. The method 500 might include the non-coordinating base station transmitting, via the Xn interface to the coordinating base station, a role change response (not shown) accepting the role of the coordinator. For example, as described in connection with FIG. 3B, the coordinator base station, e.g., the base station 102A, can help coordinating the TDM/FDM/SDM/CDM of radar sensing cooperation. In addition, the coordinator base station can also allocate the base stations for radar sensing receptions and transmission. The coordinator base station can allocate a subset of base stations to perform the bi-static/multi-static transmission while another subset of base stations to perform the bi-static/multi-static reception. The allocation can change dynamically based on the base station sensing requirements, for example, based on the base station capability, such as loading of each base station. A different base station (e.g., 102C) might later become the coordinator of the RCS.

Using the method 500, the non-coordinating base station (e.g., 102B or 102C) receives base station capability information request message from the coordinating base station (e.g., 102A) and transmits base station capability information response message to the coordinating base station. Thus, the coordinating base station forms the RCS to perform the multi-static or bi-static radar signal processing. The multi-static or bi-static radar signal processing alleviates the requirement for full duplex capability for radar processing for the base station(s), improves the radar signal SNR, increases the accuracy of radar processing, and reduces the processing cost at the base station side. In addition, the method allows reuse of downlink communication signals for radar sensing purposes to improve the overall efficiency.

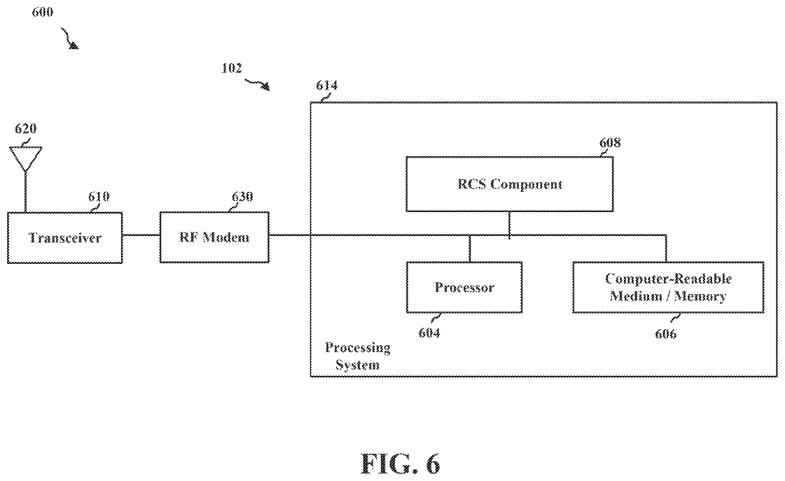

FIG. 6 is a block diagram 600 illustrating a base station 102 that can implement various aspects of an RCS for multi-static or bi-static radar signal processing. The base station 102 includes one or more radio frequency (RF) modems 630 and a processing system 614. The processing system 614 is coupled to the RF modems 630 and a transceiver 610. The transceiver 610 is coupled to one or more antennas 620. The transceiver 610 communicates with various other apparatus over a transmission medium. The transceiver 610 receives a signal from the one or more antennas 620, extracts information from the received signal, and provides the extracted information to the processing system 614. The processing system 614 includes a processor 604 coupled to a computer-readable medium/memory 606. The processor 604 is responsible for general processing, including the execution of software stored on the computer-readable medium/memory 606. The software, when executed by the processor 604, causes the processing system 614 to perform the various functions described above, in connection with FIGS. 2, 3A-3B, 4A-4B and 5A-5B. The computer-readable medium/memory 606 may also be used for storing data that is manipulated by the processor 604 when executing software. The processing system 614 further includes an RCS component 608. The RCS component 608 may be software components running in the processor 604, resident/stored in the computer readable medium/memory 606, one or more hardware components coupled to the processor 604, or some combination thereof. The RCS component 608 performs the method as described in connection with FIGS. 2, 3A-3B, 4A-4B and 5A-5B.

The technical solutions presented herein use multiple base stations to form the RCS for multi-static or bi-static radar signal processing. Within the RCS, the multiple base stations exchange messages regarding base station capabilities including radar signal processing capabilities over their Xn interfaces. A coordinator of the RCS, which can be implemented by a base station, coordinates with other base stations in the RCS regarding the multi-static or bi-static radar processing. The coordinator might schedule the radar resource for radar waveforms in terms of time, frequency, space and sequence signature. One or more base stations of the RCS might transmit radar waveforms and other base stations of the RCS might receive the radar waveforms as reflected from an object. The transmitting (TX) base station(s) might pass in-phase and quadrature (IQ) samples of the radar waveforms for interference cancelation to the receiving (RX) base station(s) over the Xn interface(s). The Rx base station(s) might send interference-reduced radar reception information messages to the TX base station(s) over the Xn interface(s). The TX base station(s) might determine object properties/parameters and transmit the object information to the (RX) base station(s) and other neighbor BSs over the Xn interface.

By the technical solutions discussed above, the multi-static or bi-static radar signal processing performed by the RCS 201 advantageously alleviates the requirement for full duplex capability for radar processing for the base station(s), improves the radar signal SNR, increases the accuracy of radar processing, and reduces the operational cost at the base station side. In addition, this approach allows reuse of downlink communication signals for radar sensing purposes to improve the overall efficiency.

Method 400 and method 500 are performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof.

Method 400 and method 500 illustrate example functions used by various embodiments. Although specific function blocks (“blocks”) are disclosed in method 400 and method 500, such blocks are examples. That is, embodiments are well suited to performing various other blocks or variations of the blocks recited in method 400 and method 500. It is appreciated that the blocks in method 400 and method 500 might be performed in an order different than presented, and that not all of the blocks in method 400 and method 500 might be performed.

Unless specifically stated otherwise, terms such as “transmitting,” “receiving,” “forming,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and might not necessarily have an ordinal meaning according to their numerical designation.

Examples described herein also relate to an apparatus for performing the operations described herein. This apparatus might be specially constructed for the required purposes, or it might include a general purpose computing device selectively programmed by a computer program stored in the computing device. Such a computer program might be stored in a computer-readable non-transitory storage medium.

The methods and illustrative examples described herein are not inherently related to any particular computer or other apparatus. Various general purpose systems might be used in accordance with the teachings described herein, or it might prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted might occur out of the order noted in the figures. For example, two figures shown in succession might in fact be executed substantially concurrently or might sometimes be executed in the reverse order, depending upon the functionality/acts involved.

Although the method operations were described in a specific order, other operations might be performed in between described operations, described operations might be adjusted so that they occur at slightly different times or the described operations might be distributed in a system which allows the occurrence of the processing operations at various intervals associated with the processing.

These apparatus and methods are illustrated in the accompanying drawings by various blocks, components, circuits, processes, algorithms, etc. (collectively referred to as “elements”). These elements might be implemented using electronic hardware, computer software, or any combination thereof.

For example, an element, or any portion of an element, or any combination of elements might be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure.

The functions described might be implemented in hardware, software, or any combination thereof. If implemented in software, the functions might be stored on or encoded as one or more instructions or code on a computer-readable medium. Computer-readable media includes computer storage media. Storage media might be any available media that can be accessed by a computer. For example, such computer-readable media might comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various units, circuits, or other components might be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” might also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as might be suited to the particular use contemplated. Accordingly, the present embodiments are to be considered as illustrative and not restrictive, and the present disclosure is not to be limited to the details given herein, but might be modified within the scope and equivalents of the appended claims.

The following examples are illustrative only and may be combined with other examples or teachings described herein, without limitation.

Example 1 is a method, by a first base station, comprising: transmitting, via an Xn interface to a second base station, a message requesting base station capability information of the second base station; receiving, via the Xn interface from the second base station, a base station capability information response; and forming a radar coordination set (RCS) with at least the second base station based on the base station capability information response.

Example 2 may be combined with example 1 and includes that the receiving the base station capability information response comprises: receiving, from the second base station, radar signal processing capability.

Example 3 may be combined with example 1 and includes that the receiving the base station capability information response comprises: receiving, from the second base station, location information.

Example 4 may be combined with any of examples 1-3 and includes that the receiving the base station capability information response comprises: receiving, from the second base station, at least one of: antenna array capability for an angular resolution, radar signal processing capability, or in-phase and quadrature (I/Q) sample processing capability.

Example 5 may be combined with any of examples 1-4 and includes that the receiving the base station capability information response comprises: receiving load information of the second base station.

Example 6 may be combined with any of examples 1-5 and includes that forming the RCS comprises: transmitting, via the Xn interface to the second base station, an RCS configuration message comprising a configuration of the RCS regarding multiple radar waveforms being transmitted.

Example 7 may be combined with example 6 and includes that the transmitting the at RCS configuration message comprises: transmitting, via the Xn interface, information regarding the multiple radar waveforms being transmitted separately in a time domain, in a frequency domain, by different spatial/angular directions, by different code/sequence signature, or by a combination thereof.

Example 8 may be combined with example 6 and includes that the transmitting the RCS configuration message comprises: transmitting, via the Xn interface, information regarding a first subset of the RCS for multi-static radar transmission or a second subset of the RCS for multi-static radar reception.

Example 9 may be combined with example 8 and includes that the transmitting the information regarding the first subset of the RCS for transmission or the second subset of the RCS for reception comprises: updating, via the Xn interface, the first subset of the RCS or the second subset of the RCS dynamically based on radar sensing requirements.

Example 10 may be combined with any of examples 6-9 and includes that receiving, via the Xn interface from the second base station, an RCS configuration acknowledgment message accepting the configuration of the RCS.

Example 11 may be combined with any of examples 1-10 and includes that transmitting, via the Xn interface, in-phase and quadrature (IQ) samples of a baseband radar signal to the second base station.

Example 12 may be combined with example 11 and includes that transmitting, via an antenna, a modulated version of the radar signal.

Example 13 may be combined with example 12 and includes that the modulated version of the radar signal comprises a modulated downlink transmission signal for communication to a user equipment.

Example 14 may be combined with any of examples 12-13 and includes that receiving, via the Xn interface, from the second base station, reception information of the radar signal as received by the second base station with a portion of the modulated version of the radar signal being canceled.

Example 15 may be combined with example 14 and includes that the reception information includes a path delay or Doppler angle information of the radar signal as received by the second base station.

Example 16 may be combined with example 14 and includes that the modulated version of radar signal is demodulated, and the portion of the modulated version of the radar signal is cancelled based on the IQ samples.

Example 17 may be combined with any of examples 14-16 and includes that transmitting, via the Xn interface, information regarding an object detected based on the reception information.

Example 18 may be combined with example 17 and includes that the information regarding the object detected includes position or speed information related to the object.

Example 19 may be combined with any of examples 1-18 and includes that the first base station takes a role of a coordinator of the RCS for multi-static radar sensing.

Example 20 may be combined with example 19 and includes that transmitting, via the Xn interface to the second base station, a role change message requesting to transfer the role of the coordinator; and receiving, via the Xn interface from the second base station, a role change response accepting the role of the coordinator.

Example 21 may be combined with any of examples 1-20 and includes that transmitting, via the Xn interface to a third base station, a message requesting base station capability information of the third base station; receiving, via the Xn interface from the third base station, an additional base station capability information response; and adding the third base station to the RCS based on the additional base station capability information response.

Example 22 is a method, by a second base station, comprising: receiving, via an Xn interface from a first base station, a message requesting base station capability information; and transmitting, via the Xn interface to the first base station, a base station capability information response.

Example 23 may be combined with example 22 and includes that the transmitting, via the Xn interface to the first base station, the base station capability information response comprises transmitting, via the Xn interface to the first base station, at least one of: antenna array capability for an angular resolution, radar signal processing capability, in-phase and quadrature (IQ) sample processing capability, or load information.

Example 24 may be combined with any of examples 22-23 and includes that receiving, via the Xn interface from the first base station, a radar coordination set (RCS) configuration message regarding multiple radar waveforms being transmitted.

Example 25 may be combined with example 24 and includes that transmitting, via the Xn interface to the first base station, an RCS configuration acknowledgment message.

Example 26 may be combined with any of examples 22-25 and includes that receiving, via the Xn interface from the first base station, in-phase and quadrature (IQ) samples of a baseband radar signal.

Example 27 may be combined with example 26 and includes that receiving, via an antenna, a modulated version of the radar signal at an indicated frequency or time from the RCS configuration message.

Example 28 may be combined with example 27 and includes that demodulating the modulated version of the radar signal; and cancelling a portion of the radar signal based on the IQ samples.

Example 29 may be combined with any of examples 26-28 and includes that the modulated version of the radar signal comprises a downlink transmission signal for communication with a user equipment.

Example 30 may be combined with any of examples 28-29 and includes that transmitting, via the Xn interface to the first base station, reception information of the radar signal after cancelling the portion of the radar signal.

Example 31 may be combined with example 30 and includes that the reception information includes a path delay or Doppler angle information of the radar signal as received by the second base station.

Example 32 may be combined with any of examples 30-31 and includes that receiving, via the Xn interface from the first base station, information regarding an object detected based on the reception information.

Example 33 may be combined with example 32 and includes that the information regarding the object detected includes position or speed information related to the object.

Example 34 may be combined with any of examples 22-25 and includes that transmitting, via the Xn interface to a third base station, in-phase and quadrature (IQ) samples of a baseband radar signal.

Example 35 may be combined with example 34 and includes that transmitting, via an antenna, a modulated version of the radar signal.

Example 36 may be combined with example 35 and includes that the modulated version of the radar signal comprises a modulated downlink transmission signal for communication to a user equipment.

Example 37 may be combined with any of examples 34-36 and includes that receiving, via the Xn interface from the first base station, information regarding an object detected based on reception information from the third base station.

Example 38 may be combined with example 37 and includes that the information regarding the object detected includes position or speed information related to the object.

Example 39 may be combined with any of examples 22-38 and includes that receiving, via the Xn interface from the first base station, a role change message requesting to transfer a role of a coordinator of the RCS to the second base station; and transmitting, via the Xn interface to the first base station, a role change response accepting the role of the coordinator.

Example 40 is base station, comprising: one or more radio frequency (RF) modems; a processor coupled to the one or more RF modems; and at least one memory storing executable instructions, the executable instructions to manipulate at least one of the processor or the one or more RF modems to perform the method of any of claims 1-39.

1. A method, by a first base station, comprising:
transmitting, via an Xn interface to a second base station a message requesting base station capability information of the second base station;
receiving, via the Xn interface from the second base station, a base station capability information response; and
forming a radar coordination set (RCS) with at least the second base station based on the base station capability information response.

2. The method of claim 1, wherein the receiving the base station capability information response comprises:
receiving, from the second base station, at least one of:
antenna array capability for an angular resolution,
radar signal processing capability,
in-phase and quadrature, I/Q, sample processing capability,
location information for a coverage of a geographic area, or
load information.

3. The method of claim 1, wherein the forming the RCS comprises:
transmitting, via the Xn interface to the second base station, an RCS configuration message comprising a configuration of the RCS regarding multiple radar waveforms being transmitted.

4. The method of claim 3, further comprising:
receiving, via the Xn interface from the second base station, an RCS configuration acknowledgment message accepting the configuration of the RCS.

5. The method of claim 1, further comprising:
transmitting, via the Xn interface, in-phase and quadrature (IQ) samples of a baseband radar signal to the second base station.

6. The method of claim 5, further comprising:
transmitting, via an antenna, a modulated version of the radar signal.

7. The method of claim 6, further comprising:
receiving, via the Xn interface, from the second base station, reception information of the radar signal as received by the second base station with a portion of the modulated version of the radar signal being canceled.

8. The method of claim 7, wherein the reception information includes a path delay or Doppler angle information of the radar signal as received by the second base station.

9. The method of claim 7, further comprising:
transmitting, via the Xn interface, information regarding an object detected based on the reception information.

10. A method, by a second base station, comprising:
receiving, via an Xn interface from a first base station, a message requesting base station capability information; and
transmitting, via the Xn interface to the first base station, a base station capability information response.

11. The method of claim 10, further comprising:
receiving, via the Xn interface from the first base station, a radar coordination set (RCS) configuration message regarding multiple radar waveforms being transmitted.

12. The method of claim 11, further comprising:
transmitting, via the Xn interface to the first base station, an RCS configuration acknowledgment message.

13. The method of claim 10, further comprising:
receiving, via the Xn interface from the first base station, in-phase and quadrature (IQ) samples of a baseband radar signal.

14. The method of claim 13, further comprising:
receiving, via the Xn interface from the first base station, information regarding an object detected based on the reception information.

15. A base station, comprising:
one or more radio frequency, RF, modems;
a processor coupled to the one or more RF modems; and
at least one memory storing executable instructions, the executable instructions to manipulate at least one of the processor or the one or more RF modems to:
transmit, via an Xn interface to a second base station, a message requesting base station capability information of the second base station;
receive, via the Xn interface from the second base station, a base station capability information response; and
form a radar coordination set (RCS) with at least the second base station based on the base station capability information response.

16. The base station of claim 15, wherein, to receive the base station capability information response, the executable instructions to manipulate the at least one of the processor or the one or more RF modems to:
receive, from the second base station, at least one of:
antenna array capability for an angular resolution,
radar signal processing capability,
in-phase and quadrature, I/Q, sample processing capability,
location information for a coverage of a geographic area, or
load information.

17. The base station of claim 15, wherein, to form the RCS, the executable instructions to manipulate the at least one of the processor or the one or more RF modems to:
transmit, via the Xn interface to the second base station, an RCS configuration message comprising a configuration of the RCS regarding multiple radar waveforms being transmitted.

18. The base station of claim 17, the executable instructions further to manipulate the at least one of the processor or the one or more RF modems to:
receive, via the Xn interface from the second base station, an RCS configuration acknowledgment message accepting the configuration of the RCS.

19. The base station of claim 15, the executable instructions further to manipulate the at least one of the processor or the one or more RF modems to:
transmit, via the Xn interface, in-phase and quadrature (IQ) samples of a baseband radar signal to the second base station.

20. The base station of claim 19, the executable instructions further to manipulate the at least one of the processor or the one or more RF modems to:
transmit, via an antenna, a modulated version of the radar signal.
